(19) United States
(12) Patent Application Publication
(10) Pub. No.: US 2024/0327614 A1
(43) Pub. Date: Oct. 3, 2024

(54) METHOD FOR MANUFACTURING PLAY-OF-COLOR ARTICLE, PLAY-OF-COLOR ARTICLE, AND PLAY-OF-COLOR PRODUCT INCLUDING THE SAME

(71) Applicants: Taiwan Green Point Enterprises Co., Ltd., Taichung City (TW); Jabil Circuit (Singapore) Pte. Ltd., Singapore (SG)

(72) Inventors: Yi-Chung Su, Taichung City (TW); Chih-Wen Lin, Toufen Township (TW); Chin-Yen Chou, Taichung City (TW); Jiun-Shiuan Hsu, Taichung City (TW); Yen-Hao Lin, Taichung City (TW); Chang-Yu Lin, Taichung City (TW)

(73) Assignees: Taiwan Green Point Enterprises Co., Ltd., Taichung City (TW); Jabil Circuit (Singapore) Pte. Ltd., Singapore (SG)

(21) Appl. No.: 18/613,705

(22) Filed: Mar. 22, 2024

(30) Foreign Application Priority Data
Mar. 29, 2023 (TW) 112112019

(51) Int. Cl. C08K 9/04; B29B 13/00; B29C 35/08; B29C 45/00; B29C 45/26; B29C 45/73; B29K 33/00; B29K 105/00; B29K 105/16; B29L 31/00; C08J 3/215; C08J 3/28

(52) U.S. Cl. CPC C08K 9/04; B29B 13/00; B29C 35/0805; B29C 45/0001; B29C 45/2681; B29C 45/73; C08J 3/215; C08J 3/28; B29B 2013/002; B29C 2035/0827; B29K 2033/12; B29K 2105/0073; B29K 2105/16; B29L 2031/7432; C08K 2201/005

(57) ABSTRACT

A method for manufacturing a play-of-color article includes the steps of: (a) providing a first mixture that contains a solvent and a plurality of functionalized colloidal particles; (b) replacing the solvent of the first mixture with a polymer solution that contains polymers, thereby obtaining a second mixture; (c) adding an initiator to the second mixture to obtain a third mixture, followed by injecting the third mixture into a mold and disturbing the third mixture, so that the third mixture is formed with a pattern; (d) leaving the third mixture to stand, so as to allow the functionalized colloidal particles therein to self-assemble to form a crystalline arrangement, thereby obtaining a fourth mixture; and (e) subjecting the polymers in the fourth mixture to a cross-linking reaction, thereby obtaining the play-of-color article. A play-of-color article manufactured by the method, and a play-of-color product including the play-of-color article are also provided.

### CROSS-REFERENCE TO RELATED APPLICATION

This application claims priority to Taiwanese Invention patent application Ser. No. 11/211,2019, filed on Mar. 29, 2023, the entire disclosure of which is incorporated by reference herein.

### FIELD

The disclosure relates to a method for manufacturing a play-of-color article. The disclosure also relates to a play-of-color article manufactured by the method, and a play-of-color product including the play-of-color article.

### BACKGROUND

An opal is a mineral formed by deposition of silicon dioxide particles, and has a photonic crystal structure formed by periodic and tight packaging of the silicon dioxide particles. When a light beam travels through the opal from different angles, different degrees of diffraction may occur due to different photonic energy gaps in the photonic crystal structure, thereby producing a change in the color of the opal and providing a play-of-color effect thereto. In order to meet consumers' need for diversification in the appearance of a product, such as an electronic product or a wearable device, some manufacturers use an artificial opal to serve as a shell for the product, so that the shell exhibits a play-of-color effect, thereby enhancing the appearance of the product. A method for producing the artificial opal is approximately as follows: preparing a plurality of silicon dioxide particles with particle sizes ranging from 300 nm to 400 nm; preparing a reaction solution that contains the silicon dioxide particles and a solvent, followed by leaving the reaction solution to stand for several weeks to several months, so as to allow the silicon dioxide particles to deposit and to undergo self-rearrangement; removing the solvent by a drying process, so as to obtain a semi-finished product; and calcining the semi-finished product, thereby obtaining the artificial opal having a photonic crystal structure and a play-of-color effect.

However, production of the foregoing artificial opal takes several weeks to several months, which is time-consuming and costly. Moreover, patterns formed on the artificial opal are determined by natural deposition of the silicon dioxide particles, which is not conducive to the diversification in appearance of the artificial opal.

### SUMMARY

Therefore, in a first aspect, the present disclosure provides a method for manufacturing a play-of-color article that can alleviate at least one of the drawbacks of the prior art. The method includes:
(a) providing a first mixture that contains a solvent and a plurality of functionalized colloidal particles dispersed in the solvent;
(b) replacing the solvent of the first mixture with a polymer solution that contains polymers, so that the functionalized colloidal particles are uniformly dispersed in the polymer solution, thereby obtaining a second mixture with an iridescent pattern;
(c) adding an initiator to the second mixture with the iridescent pattern to obtain a third mixture, followed by injecting the third mixture into a mold and disturbing the third mixture in the mold, so that the third mixture in the mold is formed with a pattern;
(d) leaving the third mixture with the pattern to stand, so as to allow the functionalized colloidal particles in the third mixture to self-assemble to form a crystalline arrangement, thereby obtaining a fourth mixture containing colloidal photonic crystals; and
(e) subjecting the polymers in the fourth mixture to a cross-linking reaction, so that the polymers are solidified, thereby obtaining the play-of-color article.

In a second aspect, the present disclosure provides a play-of-color product that can alleviate at least one of the drawbacks of the prior art. The play-of-color product includes:
a body portion; and
a play-of-color article that covers a surface of the body portion or is embedded in a surface region of the body portion, and that includes a polymer body obtained by cross-linking and solidifying polymers and a plurality of functionalized colloidal particles uniformly dispersed in the polymer body, each of the functionalized colloidal particles having a core that is derived from a colloidal particle, and a modified layer that is formed on part of a surface of the core.

In a third aspect, the present disclosure provides a play-of-color article which is manufactured by the aforesaid method that can alleviate at least one of the drawbacks of the prior art. The play-of-color article includes:
a polymer body that is obtained by cross-linking and solidifying polymers;
a plurality of functionalized colloidal particles that are uniformly dispersed in the polymer body, each of the functionalized colloidal particles having a core that is derived from a colloidal particle, and a modified layer that is formed on part of a surface of the core.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic flow chart illustrating an embodiment of a method for manufacturing a play-of-color article according to the disclosure.

FIG. 2 is a schematic view illustrating an embodiment of a play-of-color product according to the disclosure.

FIG. 3 is an enlarged view of portion “A” as shown in FIG. 2, illustrating structures of functionalized colloidal particles therein.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

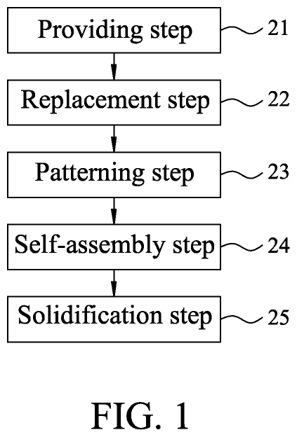

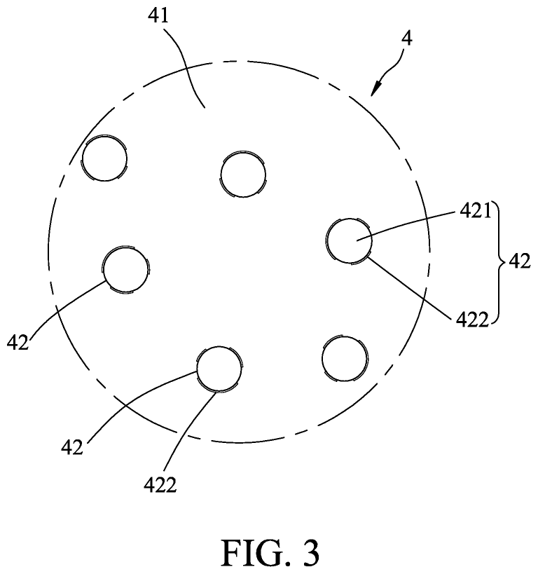

Referring to FIGS. 1 and 3, a method for manufacturing a play-of-color article 4 includes steps (a) to (e).

In step (a) (hereinafter referred to as “providing step 21”), a first mixture (not shown) that contains a solvent and a plurality of functionalized colloidal particles 42 dispersed in the solvent is provided. In certain embodiments, the functionalized colloidal particles 42 are formed by subjecting a plurality of colloidal particles to surface modification using a surface modifying agent that contains a hydrophobic functional group or a hydrophilic functional group. Each of the functionalized colloidal particles 42 has a core 421 that is derived from one of the colloidal particles, and a modified layer 422 that is formed on part of a surface of the core 421. That is to say, the modified layer 422 is defined by surface areas of the one of the colloidal particles that have undergone the surface modification.

In this embodiment, the solvent is anhydrous alcohol, and examples of the solvent may include, but are not limited to, methanol, a mixture of methanol and ethanol, acetone, dimethylformamide (DMF), dimethyl sulfoxide (DMSO), and N-methyl-2-pyrrolidone (NMP). As shown in FIG. 3, the functionalized colloidal particles 42 are obtained by subjecting a plurality of silicon dioxide particles (serving as the colloidal particles) to surface modification using a surface modifying agent that contains a hydrophobic functional group. In addition, the surface modifying agent is a silane coupling agent, such as gamma (γ)-methacryloxypropyltrimethoxysilane (MPS).

Specifically, the providing step 21 is initially conducted by preparing a reaction solution that contains anhydrous alcohol, deionized water and tetraethoxysilane (TEOS) in a weight ratio of approximately 20:4:1. Next, the reaction solution is left to stand at a temperature of 25° C. for pre-hydrolysis, followed by adding thereto 30% of ammonia water, which has a weight ratio to the tetraethoxysilane of 1:2, so as to obtain a first solution that has a pH value ranging from 11 to 12, and to allow a sol-gel process to proceed in the first solution for 40 minutes to 160 minutes, thereby obtaining a second solution having the silicon dioxide particles having an average particle size ranging from 120 nm to 250 nm and a polydispersity index (PDI) ranging from 0.02 to 0.06. Thereafter, the silane coupling agent is added to the second solution, followed by subjecting the silicon dioxide particles to surface modification at a temperature of 50° C., so that hydrophobic silane functional groups are formed on surfaces of the silicon dioxide particles, thereby obtaining the functionalized colloidal particles 42. The functionalized colloidal particles 42 have a particle size approximately equal to that of the silicon dioxide particles (i.e., the colloidal particles). Moreover, an area of the surface of the core 421 of each of the functionalized colloidal particles 42 occupied by the modified layer 422 (i.e., surface areas of a corresponding one of the silicon dioxide particles that have undergone the surface modification) accounts for 1% to 10% based on 100% of a total surface area of the core 421. Finally, the functionalized colloidal particles 42 are dispersed in anhydrous alcohol (serving as the solvent) to obtain the first mixture. The functionalized colloidal particles 42 can be dispersed in the anhydrous alcohol because of occurrence of charge repulsion force which is caused by the functionalized colloidal particles 42 having charges themselves, and of steric hindrance effect due to the formation of the modified layer 422 on the part of the surface of the core 421.

In this embodiment, the colloidal particles (i.e., the silicon dioxide particles) are synthesized by the sol-gel process, which facilitates the adjustment of process parameters, such as adjustment of process temperature, process time, or the weight ratio of the anhydrous alcohol, the deionized water and the tetraethoxysilane contained in the reaction solution, so as to control the particle size and particle size distribution of the colloidal particles, thereby obtaining the colloidal particles having a good monodispersity.

In some embodiments, the silane coupling agent may be selected from the group consisting of an aminosilane, an epoxysilane, a thiosilane, a methacryloxysilane, a vinylsilane, an ureidosilane, and an isocyanate silane.

It should be noted that, regarding surface modification of the colloidal particles, in the providing step 21, the surface modifying agent is not limited to those mentioned above and may also be selected from other different types of surface modifiers according to a desired property of the functionalized colloidal particles 42, such as a polarity thereof, a zeta potential thereof, or number of charges on a surface thereof.

In other embodiments, the colloidal particles may be zirconium dioxide particles formed by a sol-gel process, and surface modification thereof may be carried out using a silane coupling agent, so as to obtain the functionalized colloidal particles 42 having silane functional groups on surfaces thereof.

In still other embodiments, in the providing step 21, the colloidal particles, which may be a plurality of polymer particles, such as particles of polystyrene (PS) or particles of polymethyl methacrylate (PMMA), are formed by an emulsifier-free emulsion polymerization process.

In yet other embodiments, in the providing step 21, the functionalized colloidal particles 42 may be purchased from a manufacturer, or obtained by using the colloidal particles that are commercially available, followed by subjecting them to surface modification.

In step (b) (hereinafter referred to as “replacement step 22”), the solvent of the first mixture is replaced with a polymer solution that contains polymers, so that the functionalized colloidal particles 42 are uniformly dispersed in the polymer solution, thereby obtaining a second mixture with an iridescent pattern.

In this embodiment, in the replacement step 22, the first mixture is subjected to a solid-liquid separation process (such as a centrifugal separation process or a filtration process) so as to separate the functionalized colloidal particles 42 from the solvent, and thus removes the solvent, followed by adding the polymer solution to disperse the functionalized colloidal particles 42, so that the second mixture is obtained. In addition, the functionalized colloidal particles 42 are present in an amount ranging from 20 wt % to 50 wt % based on 100 wt % of the second mixture, and have an average center-to-center distance ranging from 100 nm to 400 nm. The polymers of the polymer solution is methyl methacrylate (MMA), which has a hydrophobic property. The functionalized colloidal particles 42 can be dispersed in the polymer solution because of the charge repulsion force and the steric hindrance effect. It should be noted that the polymer solution refers to a solution that contains reactive substances (i.e., the polymers), such as monomers, dimers, trimers, or oligomers that can be subjected to polymerization.

In step (c) (hereinafter referred to as “patterning step 23”), an initiator is added to the second mixture with the iridescent pattern to obtain a third mixture, followed by injecting the third mixture into a mold and disturbing the third mixture in the mold, so that the third mixture in the mold is formed with a pattern. In certain embodiments, the pattern may be formed by controlling at least one of an injection direction along which the third mixture is injected into the mold, and a motion mode of the mold. The initiator may be a photoinitiator or a thermal initiator.

In this embodiment, the mold is a sealed mold, so as to prevent the polymer solution containing the methyl methacrylate (MMA) from volatilization, which may cause a component ratio of the third mixture to be altered. The initiator is an azo-type free radical initiator (serving as the thermal initiator), and may be azobisisobutyronitrile (AIBN) or 2,2′-azobis(2,4-dimethylvaleronitrile) (ABVN). Specifically, in formation of the pattern, the third mixture may be injected into the mold along the injection direction that has a predetermined angle with respect to a horizontal section plane of the mold, and/or may be disturbed by shaking or rotating the mold (i.e., controlling the motion mode of the mold) in a certain direction, thereby forming the pattern with various textures caused by disturbance of the third mixture or by a change of flow regime thereof. In certain embodiments, the motion mode of the mold may include at least one of a shaking mode and a rotating mode.

In some embodiments, when the polymers of the polymer solution in the replacement step 22 are non-volatile polymers (e.g., ethylene glycol diacrylate monomers), the mold in the patterning step 23 may be an open mold. In addition, in the patterning step 23, when the initiator is the photoinitiator, the mold may be light transmissible, so as to facilitate procedure of irradiating the mold to allow a cross-linking reaction to occur, as well as solidification of the polymers that occur subsequently.

In step (d) (hereinafter referred to as “self-assembly step 24”), the third mixture with the pattern is left to stand, so as to allow the functionalized colloidal particles 42 in the third mixture to self-assemble to form a crystalline arrangement, thereby obtaining a fourth mixture containing colloidal photonic crystals. The colloidal photonic crystals of the fourth mixture have a three-dimensional structure and provide a play-of-color effect. Since the intensity of brightness and the reflectance of the third mixture gradually increase during the self-assembly of the functionalized colloidal particles 42, therefore, whether or not the crystalline arrangement is completed can be determined by observation. To illustrate further, when rising trends of the intensity of brightness and the reflectance of the third mixture decrease, the crystalline arrangement is closer to completion. Alternatively, since the functionalized colloidal particles 42 tend to be stable during the self-assembly thereof, whether or not the crystalline arrangement is completed can also be determined by observing whether changes to the pattern of the third mixture is obvious or not.

In this embodiment, because in the replacement step 22, the functionalized colloidal particles 42 can be uniformly dispersed in the polymer solution, that is to say, the functionalized colloidal particles 42 have a good dispersion property in the polymers, and hence are not prone to aggregation, in the self-assembly step 24, the self-assembly of the functionalized colloidal particles 42 in the polymers may thus be facilitated. As a result, compared with a conventional method which requires several days to several months awaiting the deposition of silicon dioxide particles, such as sedimentation and self-assembly thereof, in order to obtain colloidal photonic crystals, the self-assembly step 24 of the method according to the disclosure takes only tens of minutes to several days (e.g., 3 to 7 days) to accomplish the crystalline arrangement, thereby saving a significant amount of time and cost.

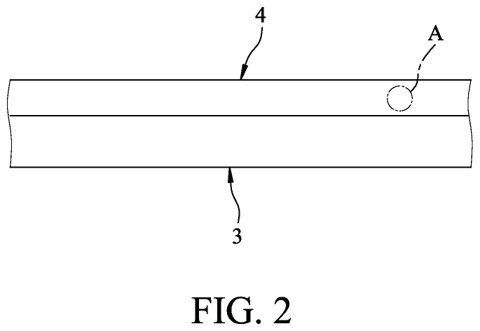

In step (e) (hereinafter referred to as “solidification step 25”), the polymers in the fourth mixture is subjected to the cross-linking reaction, so that the polymers are solidified, thereby obtaining the play-of-color article 4 (as shown in FIG. 2). In this embodiment, the initiator in the patterning step 23 is the thermal initiator, and in the solidification step 25, the cross-linking reaction is carried out by heating the mold having the fourth mixture therein at a temperature ranging from 40° C. to 70° C., so that the polymers (e.g., the monomers, the dimers, the trimers, or the oligomers) in the fourth mixture are polymerized to form a polymer body 41, thereby obtaining the play-of-color article 4.

In certain embodiments, the initiator in the patterning step 23 may be the photoinitiator, and in the solidification step 25, the cross-linking reaction may be carried out by irradiating the mold having the fourth mixture therein with ultraviolet light. The photoinitiator may be selected from the group consisting of dimethylolpropionic acid (DMPA), IRGACURE® 819, and IRGACURE® 184 (BASF, Germany).

In certain embodiments, the polymer solution in the replacement step 22, the second mixture in the patterning step 23, or the fourth mixture in the self-assembly step 24 may further be added with an agent, and the agent may be selected from the group consisting of a dye, a surfactant, luminous particles, and combinations thereof. The agent is added to allow the play-of-color article 4 to be presented with a desired color, and therefore enhances the colorful effect thereof. The dye may be an inorganic dye selected from the group consisting of carbon black, hematite, cinnabar, laterite, realgar, and combinations thereof, or may be an organic dye selected from the group consisting of an azo dye, an anthraquinone dye, a phthalocyanine dye, an arylmethane dye, a nitro dye, a fluorescent whitening agent, and combinations thereof. The surfactant is used to improve the dispersion of the functionalized colloidal particles 42 in the polymer solution, and may be selected from the group consisting of an anionic surfactant, a cationic surfactant, a zwitterionic surfactant, and a nonionic surfactant, based on desired properties of the functionalized colloidal particles 42 and the polymer solution. The luminous particles may be particles of a rare earth aluminate, such as a strontium aluminate doped with a rare earth element selected from the group consisting of europium (Eu), dysprosium (Dy), neodymium (Nd), and combinations thereof, and are used to absorb UV light or visible light and to provide a phosphorescent effect.

In this embodiment, the second mixture in the patterning step 23 is added with the dye, so that the second mixture shows a certain color, and the dye is present in an amount ranging from 0.02 wt % to 0.04 wt % based on 100 wt % of the second mixture.

It should be noted that addition of the agent can be performed at different time points as desired, as long as the addition is conducted after the providing step 21 and prior to the solidification step 25. For instance, the dye or the luminous particles may be added to the polymer solution in the replacement step 22. Alternatively, in some embodiments, the dye may be added with the third mixture into the mold in the patterning step 23, or may be added to the fourth mixture after completion of the self-assembly step 24.

In some embodiments, the addition of the agent may be omitted as required. By controlling the particle size of the functionalized colloidal particles 42 and a concentration thereof, the distance between centers of any two of the functionalized colloidal particles 42 can be adjusted, thereby achieving a color tone change of the second mixture. For example, the farther the distance between centers of any two of the functionalized colloidal particles 42 is, the greater the degree of the redshift that can be observed when a light beam passes through the second mixture or the play-of-color article 4, so as to present different play-of-color effects.

Referring to FIG. 3, the aforesaid play-of-color article 4, which is manufactured by the above-mentioned method, is also provided. The play-of-color article 4 includes:
the polymer body 41 that is obtained by cross-linking and solidifying the polymers;
the plurality of the functionalized colloidal particles 42 that are uniformly dispersed in the polymer body 41, each of the functionalized colloidal particles 42 having the core 421 that is derived from one of the colloidal particles, and the modified layer that is formed on the part of the surface of the core 421.

Referring to FIG. 2, a play-of-color product is further provided. The play-of-color product includes:
a body portion 3; and
the aforesaid play-of-color article 4 that covers a surface of the body portion 3 or is embedded in a surface region of the body portion 3.

The body portion 3 may be an electronic product, a wearable device, or one of daily necessities.

Specifically, the play-of-color article 4 may be used as a shell to cover the surface of the body portion 3 (i.e., at least part of outer surface area of the body portion 3), or may be used as a decoration that is embedded in the surface region of the body portion 3. The functionalized colloidal particles 42 may have a polydispersity index (PDI) of particle size distribution ranging from 0.02 to 0.06, which means the functionalized colloidal particles 42 have a monodisperse property. In addition, the functionalized colloidal particles 42 have an average center-to-center distance ranging from 100 nm to 400 nm, and a refractive index ranging from 1.3 to 1.9, so that when a visible light having a wavelength ranging approximately from 380 nm to 780 nm passes through the play-of-color article 4, a diffraction phenomenon will occur, giving the play-of-color article 4 a colorful appearance and allowing the same to present a play-of-color effect, thereby achieving an aesthetic purpose.

As mentioned above, in this embodiment, the functionalized colloidal particles 42 are the silicon dioxide particles that have undergone the surface modification and hence have hydrophobic functional groups (i.e., the hydrophobic silane functional groups) thereon, and have an average particle size ranging from 120 nm to 250 nm. Moreover, the polymer body 41 is made by subjecting the methyl methacrylate (MMA) to the cross-linking reaction.

In other embodiments, the functionalized colloidal particles 42 may have a polydispersity index (PDI) of particle size distribution ranging from 0.02 to not greater than 0.05, indicating they have a monodisperse property.

As mentioned above, the colloidal particles may be inorganic nanoparticles such as the zirconium dioxide particles, or may be the polymer particles, such as the particles of polystyrene (PS) or the particles of polymethyl methacrylate (PMMA). However, examples of the colloidal particles are not limited thereto, as long as they have a good monodispersity, can be dispersed because of the charge repulsion force as well as the steric hindrance effect, and hence are not prone to aggregation after being subjected to surface modification or due to inherent material characteristics thereof.

In some embodiments, the polymer body 41 may be made of a material such as polyethylene glycol diacrylate (PEGDA) that is obtained by cross-linking and solidifying ethylene glycol diacrylate. However, the material is not limited thereto.

In some embodiments, the play-of-color article 4 may be solely used, and may be made into a desired size or shape as needed by a processing process, such as a grinding process or a cutting process.

The play-of-color article 4 manufactured by the method according to the disclosure has the colloidal photonic crystals with the three-dimensional structure. When a light beam passes through the colloidal photonic crystals from different angles, different degrees of diffraction may be produced due to different photonic band gaps. Therefore, by adjusting the particle size of the functionalized colloidal particles 42, and by at least one of controlling a component ratio of the second mixture and selecting a material for preparing the second mixture in the replacement step 22, the distance between centers of any two of the functionalized colloidal particles 42 can be controlled, thereby enhancing the quality of the crystalline arrangement of functionalized colloidal particles 42, and allowing changes of a reflection wavelength of the colloidal photonic crystals of the fourth mixture in a simple manner. As a result, the play-of-color effect presented by the play-of-color article 4 changes accordingly, thereby providing diversity in color tone thereof.

In sum, in the method for manufacturing the play-of-color article 4 according to the disclosure, by adopting the providing step 21 and the replacement step 22, the functionalized colloidal particles 42 thus obtained can be dispersed in the polymer solution and are not prone to aggregation, thus facilitating the self-assembly of the functionalized colloidal particles 42 to form the crystalline arrangement in the self-assembly step 24, thereby significantly reducing the manufacturing time and cost. By adopting the pattering step 23, the third mixture can be made to have the pattern through a simple operation, so that the play-of-color article 4 thus made is provided with such pattern, allowing flexibility in the choices of the appearance and changes of color tone of the play-of-color article 4. Furthermore, the method according to the disclosure provides an easy way to control the material properties of the functionalized colloidal particles 42 in the second mixture (such as particle size, the component ratio, or center-to-center distance) and to select a material to serve as the polymers, so as to adjust a play-of-color effect of the play-of-color article 4, thereby producing changes in appearance thereof.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing a play-of-color article, comprising the steps of:
(a) providing a first mixture that contains a solvent and a plurality of functionalized colloidal particles dispersed in the solvent;
(b) replacing the solvent of the first mixture with a polymer solution that contains polymers, so that the functionalized colloidal particles are uniformly dispersed in the polymer solution, thereby obtaining a second mixture with an iridescent pattern;
(c) adding an initiator to the second mixture with the iridescent pattern to obtain a third mixture, followed by injecting the third mixture into a mold and disturbing the third mixture in the mold, so that the third mixture in the mold is formed with a pattern;
(d) leaving the third mixture with the pattern to stand, so as to allow the functionalized colloidal particles in the third mixture to self-assemble to form a crystalline arrangement, thereby obtaining a fourth mixture containing colloidal photonic crystals; and
(e) subjecting the polymers in the fourth mixture to a cross-linking reaction, so that the polymers are solidified, thereby obtaining the play-of-color article.

2. The method as claimed in claim 1, wherein in step (a), the functionalized colloidal particles are formed by subjecting a plurality of colloidal particles to surface modification using a surface modifying agent that contains a hydrophobic functional group or a hydrophilic functional group.

3. The method as claimed in claim 2, wherein the colloidal particles are manufactured by a sol-gel process or an emulsifier-free emulsion polymerization process.

4. The method as claimed in claim 3, wherein the colloidal particles have an average particle size ranging from 120 nm to 250 nm and a polydispersity index (PDI) ranging from 0.02 to 0.06.

5. The method as claimed in claim 1, wherein in step (b), the first mixture is subjected to a solid-liquid separation process to remove the solvent, followed by adding the polymer solution to disperse the functionalized colloidal particles.

6. The method as claimed in claim 1, wherein the functionalized colloidal particles are present in an amount ranging from 20 wt % to 50 wt % based on 100 wt % of the second mixture.

7. The method as claimed in claim 1, wherein the functionalized colloidal particles have an average center-to-center distance ranging from 100 nm to 400 nm.

8. The method as claimed in claim 1, wherein in step (c), the initiator is a thermal initiator.

9. The method as claimed in claim 8, wherein in step (e), the cross-linking reaction is carried out by heating the mold having the fourth mixture therein at a temperature ranging from 40° C. to 70° C.

10. The method as claimed in claim 1, wherein in step (c), the initiator is a photoinitiator.

11. The method as claimed in claim 10, wherein in step (e), the cross-linking reaction is carried out by irradiating the mold having the fourth mixture therein with ultraviolet light.

12. The method as claimed in claim 1, wherein the polymer solution in step (b), the second mixture in step (c), or the fourth mixture in step (d) is further added with an agent.

13. The method as claimed in claim 12, wherein the agent is selected from the group consisting of a dye, a surfactant, luminous particles, and combinations thereof.

14. The method as claimed in claim 1, wherein in step (c), the pattern is formed by controlling at least one of an injection direction along which the third mixture is injected into the mold, and a motion mode of the mold.

15. The method as claimed in claim 14, wherein the motion mode of the mold includes at least one of a shaking mode and a rotating mode.

16. A play-of-color product, comprising:
a body portion; and
a play-of-color article that covers a surface of the body portion or is embedded in a surface region of the body portion, and that includes a polymer body obtained by cross-linking and solidifying polymers and a plurality of functionalized colloidal particles uniformly dispersed in the polymer body, each of the functionalized colloidal particles having a core that is derived from a colloidal particle, and a modified layer that is formed on part of a surface of the core.

17. The play-of-color product as claimed in claim 16, wherein the functionalized colloidal particles have an average particle size ranging from 120 nm to 250 nm.

18. The play-of-color product as claimed in claim 16, wherein the functionalized colloidal particles have a polydispersity index (PDI) of particle size distribution ranging from 0.02 to 0.06, and an average center-to-center distance ranging from 100 nm to 400 nm.

19. A play-of-color article, which is manufactured by the method as claimed in claim 1, comprising:
a polymer body that is obtained by cross-linking and solidifying polymers;
a plurality of functionalized colloidal particles that are uniformly dispersed in the polymer body, each of the factionalized colloidal particles having a core that is derived from a colloidal particle, and a modified layer that is formed on part of a surface of the core.
